(19) United States
(12) Patent Application Publication
(10) Pub. No.: US 2018/0065170 A1
(43) Pub. Date: Mar. 8, 2018

(54) THREE COMPONENT POLYURETHANE BINDER SYSTEM

(71) Applicant: ASK Chemicals LLC, Dublin, OH (US)

(72) Inventors: Xianping WANG, Dublin, OH (US); Mark STANCLIFFE, Herefordshire (GB); Christian PRIEBE, Wuelfrath (DE); Joerg KROKER, Powell, OH (US)

(21) Appl. No.: 15/812,364

(22) Filed: Nov. 14, 2017

Related U.S. Application Data
(63) Continuation of application No. PCT/US16/32657, filed on May 16, 2016.
(60) Provisional application No. 62/161,598, filed on May 14, 2015.

(51) Int. Cl. B22C 1/22; B22C 9/02; B22C 3/00; C08G 18/00; C08L 75/04; C08L 83/02; C01B 7/19

(52) U.S. Cl. CPC B22C 1/2273; B22C 9/02; B22C 3/00; C01B 7/191; C08L 75/04; C08L 83/02; C08G 18/006

(57) ABSTRACT

An organic binder system is mixed with molding material for sand casting in the metals industry. The organic binder system has three parts, the first two of which are conventional and are used in the cold box or no bake process. The third part, which is combined with the first two parts at the time of use, contains at least an alkyl silicate and, optionally, a bipodal aminosilane. In some embodiments, an amount of hydrofluoric acid is included in one or both of the first two parts. Use of the organic binder system provides improved tensile strength in the mold, especially in high relative humidity.

### CROSS-REFERENCE TO RELATED APPLICATIONS

This application is a bypass continuation of, and makes a claim of priority to, PCT/US2016/032657, filed on 16 May 2016, which is a non-provisional application of, and claims priority to, U.S. provisional application 62/161598, filed on 14 May 2015. Both priority applications are incorporated by reference as if fully recited herein.

### TECHNICAL FIELD

This invention relates to a three-part organic binder system for use in the cold box or no bake process, in which the two conventional binder precursor parts, which are combined at the time of use, are accompanied by a third part that comprises an alkyl silicate and, optionally, a bipodal aminosilane. Some aspects of the invention also relate to the inclusion of an amount of hydrofluoric acid in one or both of the binder precursor parts.

### BACKGROUND OF THE ART

When producing molds and cores, polyurethane-based binder systems are used in large amounts, in particular for mold and core production for the cold-box or polyurethane no-bake process. These systems require solvents and it is an on-going need to reduce emissions from these systems when used.

As is described in U.S. Pat. No. 6,465,542, to Torbus, polyurethane-based binder systems for the cold-box and for the polyurethane no-bake process are known. Such binder systems typically comprise two essential binder components. The first is a polyol component which comprises a compound having at least two —OH groups per molecule. The second is a polyisocyanate component which comprises a compound binder having at least two isocyanate groups per molecule. Once solvents are included with the respective components, they are usually packaged and sold in separate containers, only to be combined at the time of use.

The specific details of the polyol and polyisocyanate components are well documented in the art, so they are not further described here. However, there is a solvent employed with at least one of the components, and, commonly, a solvent is used with both components. Both the polyol and the polyisocyanate components will be used in a liquid form. Although liquid polyisocyanate can be used in undiluted form, a solid or viscous polyisocyanate can be used in the form of a solution in an organic solvent. In some instances, the solvent can account for up to 80% by weight of the polyisocyanate solution. When the polyol used in the first component is a solid or highly viscous liquid, suitable solvents will be used to adjust viscosity to allow for adequate application properties.

As the Torbus patent teaches, the solvents selected for use with the components do not participate in a relevant manner in the catalyzed reaction between the polyisocyanate and polyol compounds, but the solvents may very well influence the reaction. For example, the two binder components have substantially different polarities. This limits the number of solvents that may be used. If the solvents are not compatible with both binder components, complete reaction and curing of a binder system is very unlikely. Although polar solvents of the protic and aprotic type are usually good solvents for the polyol compound, they are not very suitable for the polyisocyanate compound. Aromatic solvents in turn are compatible with polyisocyanates but are not wholly suitable for polyol resins.

Torbus and others have attempted to adjust solvent compositions to limit the emissions of benzene and other aromatic species during the pouring of molten metal to produce a casting in a mold, in which the binder system holds the foundry sand of the mold together. These emissions occur not only during pouring of the molten metal, but also from evaporation and devolatilization prior to the pour. The emissions constitute significant workplace pollution that cannot be effectively trapped by protective measures, such as extractor hoods or the like. However, it appears that the molds produced from binder systems, such as that taught in the Torbus patent, leave room for performance improvement, especially when high relative humidity is encountered.

### SUMMARY

These shortcomings of the prior art are overcome at least in part by a binder system for a molding material mixture. The binder system is provided in three components, which are combined only at, the time of use. Of these, the first and second components are a first organic binder component and a second organic binder component, the second component being complementary to the first organic binder component to form a polymer in the presence of a catalyst. These components can be conventional. The third component comprises an alkyl silicate component.

In one embodiment, the first component is a polyol component, comprising a phenolic base resin with at least 2 hydroxy groups per molecule, the polyol component being devoid of polyisocyanates. The second component is a polyisocyanate component, comprising a polyisocyanate compound with at least 2 isocyanate groups per molecule, the isocyanate component being devoid of polyols, such that combining and curing the combination results in a phenolic urethane polymer.

In some embodiments, the alkyl silicate component comprises tetraethyl orthosilicate (TEOS). It can also comprise an oligomer of an alkyl silicate. The third component may also include a bipodal aminosilane, especially bis(trimethoxysilylpropyl)amine. When present, the bipodal aminosilane may represent about one-third the weight of the alkyl silicate present in the third component.

In some embodiments, at least one of the first two binder components may further comprise an amount of hydrofluoric acid.

Some embodiments of the inventive concept will be provided by a molding material mixture that comprises a refractory mold base material and an appropriate amount of the organic binder system for producing a mold suitable for sand casting of a molten metal.

### DETAILED DESCRIPTION OF THE PREFERRED EMBODIMENTS

A solution to these mold performance problems has apparently been found in a binder composition that uses a three-component approach to provide a polyurethane cold box (PUCB) binder system. In such a system, the Part I component comprises a polyol base resin and a set of suitable complements, the Part II component comprises a polyisocyanate accompanied by a set of suitable complements and the Part III component comprises an alkyl silicate compound, such as tetraethyl ortho silicate (TEOS), alkyl silicate oligomers and, optionally, a bipodal aminosilane.

TEOS, which is also referred to as tetraethoxysilane, is also identified by the GAS Registry Number 78-10-4. Structurally, it has four ethyl groups that are attached to the oxygen atoms in an orthosilicate nucleus. TEOS is commercially available at 99.999% purity from Sigma-Aldrich and other sources.

Bipodal aminosilanes are characterized by a general structure

(R¹O)₃—Si—R²—NH—R²—Si(OR¹)₃

where R¹ is an alkyl group, including methyl, ethyl or propyl, as well as mixtures thereof. R² is an alkylene linkage, including propylene, butylene, pentylene, as well as mixtures thereof. An example of an appropriate bipodal aminosilane is bis(trimethoxysilylpropyl)amine, which is commercially available from Evonik Industries under the designation DYNASYLAN 1124.

In an example of a binder system that is provided as three separate components and that is catalytically curable upon mixing, the first component comprises: a polyol, such as a phenolic resin having, at a minimum, two —OH groups per molecule; at least one solvent and a fluorinated acid. The second component comprises: a polyisocyanate having, at a minimum, two isocyanate groups per molecule; a solvent and, optionally, a fluorinated acid. The third component comprises an alkyl silicate component, selected from the group consisting of: alkyl silicates, alkyl silicate oligomers and mixtures thereof, and, optionally, a bipodal aminosilane.

The phenolic resin and the polyisocyanate can be selected from the group consisting of the compounds conventionally known to be used in the cold-box process or the no-bake process, as the inventive concept is not believed to inhere in these portions of the composition.

Referring more particularly to the phenolic resin, it is generally selected from a condensation product of a phenol with an aldehyde, especially an aldehyde of the formula RCHO, where R is hydrogen or an alkyl moiety having from 1 to 8 carbon atoms. The condensation reaction is carried out in the liquid phase, typically at a temperature below 130 degrees C. A number of such phenolic resins are commercially available and will be readily known.

A preferred phenolic resin component would comprise a phenol resin of the benzyl ether type. It can be expedient in individual cases to use an alkylphenol, such as o-cresol, p-nonylphenol or p-tert-butylphenol, in the mixture, in particular with phenol, for the preparation of the phenol resin. Optionally, these resins can feature alkoxylated end groups which are obtained by capping hydroxymethylene groups with alkyl groups like methyl, ethyl, propyl and butyl groups.

As to the polymeric isocyanate, it may be preferred to use a polyisocyanate component that comprises diphenylmethane diisocyanate (MDI), although a number of commercially-available polymeric isocyanates are directed for this specific market. The isocyanate component (second component) of the two-component binder system for the cold-box or polyurethane no-bake process usually comprises an aliphatic, cycloaliphatic or aromatic polyisocyanate having preferably between two and five isocyanate groups; mixtures of such polyisocyanates may also be used. Particularly suitable polyisocyanates among the aliphatic polyisocyanates are, for example, hexamethylene diisocyanate, particularly suitable ones among the alicyclic polyisocyanates are, for example, 4,4′-dicyclohexylmethane diisocyanate and particularly suitable ones among the aromatic polyisocyanates are, for example, 2,4′- and 2,6′-toluene diisocyanate, diphenylmethane diisocyanate and their dimethyl derivatives. Further examples of suitable polyisocyanates are 1,5-naphthalene diisocyanate, triphenylmethane triisocyanate, xylene diisocyanate and their methyl derivatives, polymethylene/polyphenyl isocyanates (polymeric MDI), etc. Although all polyisocyanates react with the phenol resin with formation of a crosslinked polymer structure, the aromatic polyisocyanates are preferred in practice. Diphenylmethane diisocyanate (MDI), triphenylmethane triisocyanate, polymethylene polyphenyl isocyanates (polymeric MDI) and mixtures thereof are particularly preferred.

The polyisocyanate is used in concentrations which are sufficient to effect curing of the phenol resin. In general, 10-500% by weight, preferably 20-300% by weight, based on the mass of (undiluted) phenol resin used, of polyisocyanate are employed. The polyisocyanate is used in liquid form; liquid polyisocyanate can be used in undiluted form, and solid or viscous polyisocyanates are used in the form of a solution in an organic solvent, it being possible for the solvent to account for up to 80% by weight of the polyisocyanate solution.

Several solvents can be used in the Part I and Part II components. One is a dibasic ester, commonly a methyl ester of a dicarboxylic acid. Sigma-Aldrich sells a dibasic ester of this type under the trade designation DBE, which is believed to have the structural formula CH₃O₂C(CH₂)ₙCO₂CH₃, where n is an integer between 2 and 4. Another solvent is kerosene, which is understood to be the generic name of a petroleum distillate cut having a boiling point in the range of 150 to 275 degrees C.

Other solvents that are useful are sold commercially as AROMATIC SOLVENT 100, AROMATIC SOLVENT 150, and AROMATIC SOLVENT 200, which are also respectively known as SOLVESSO 100, SOLVESSO 150 and SOLVESSO 200. They have the respective CAS Registry Numbers 64742-95-6, 64742-95-5 and 64742-94-5. While SOLVESSO is an expired registered trademark of Exxon, the solvents are referred to by those designations even when originating from other sources.

Performance additives are also included in the respective parts of the formulation. In the Part I component, an especially preferred performance additive is hydrofluoric acid (which is commonly used as a 49% aqueous solution, but it may be used in different dilution or with a different diluent). Coupling agents and additives based on fatty acids can also be used. In the Part II component, the preferred performance additives would include modified fatty oil and bench life extenders, which would include phosphoroxytrichloride and benzyl phosphoroxy dichloride.

In one particular formulation, the Part I component would consist of, on a weight basis:

| INGREDIENT | Weight % |
|---|---|
| Phenolic base resin | 40-65 |
| Dibasic ester | 0-15 |
| AROMATIC SOLVENTS | 10-35 |
| Hydrofluoric acid | 0.05-1 |
| TOTAL | 100.00 |

A corresponding Part II component would consist, on a weight basis, of the following:

| INGREDIENT | Weight % |
|---|---|
| MDI | 60-100 |
| AROMATIC SOLVENTS | 10-20 |
| Kerosene | 1-10 |
| Performance additives | 0.1-5 |
| TOTAL | 100.00 |

In the same formulation, the Part Ill component would comprise TEOS and a bipodal aminosilane. at any weight ratio from 100/0 to 0/100.

To demonstrate the positive effect provided by the Part Ill component, a tensile strength test was conducted on cured dog bone specimens. In each case, Parts I and II, as generically described above, were a commercially-available system available from ASK Chemicals, with Part I being ISOCURE FOCUS 100 and Part II being ISOCURE FOCUS 201, in a 55/45 weight ratio. This binder system represents phenolic urethane cold-box technology, in which the preferred gassing agent is dimethyl isopropyl amine. In all of the cases, the binder was applied at a rate of 1% by weight of the combined Part I and Part II to a commercially available WEDRON 410 sand.

In Example A, there was no Part III component, that is, it was a baseline case.

In Example B, the Part III component was entirely TEOS, present at 6% by weight, based on the binder.

In Example C, the Part III component was DYNASYLAN 1124, present at 4% by weight based on the binder. DYNASYLAN 1124 is a secondary amino functional methoxy-silane possessing two symmetrical silicon atoms, as described by its producer Evonik Industries AG of Hanau-Wolfgang, Germany, so it qualifies as a bipodal aminosilane as described in this application.

In Example D, the Part III component was also DYNASYLAN 1124, but present at 2% by weight based on the binder.

In Example E, the Part III component was a mixture of TEOS and DYNASYLAN 1124, the mixture present at 4% by weight, based on the binder. The mixture was 3 parts by weight TEOS per 1 part by weight of DYNASYLAN 1124.

In Example F, the Part III component was SILQUEST A-1100, present at 4% by weight based on the binder. SILQUEST A-1100 is a silane coupling agent, commercially available from Momentive, which characterizes the formulation as a versatile amino-functional silane coupling agent for bonding inorganic substrates and organic polymers. It is believed that the major component of SILQUEST A-1100 is gamma-aminopropyltriethoxysilane.

Upon preparing test specimens, the following tensile strength results were obtained (in psi):

TABLE 1

| | Example | | | | | |
|---|---|---|---|---|---|---|
| | A | B | C | D | E | F |
| 0 hr Bench | | | | | | |
| life | | | | | | |
| 30 seconds | 153 | 164 | 160 | 167 | 190 | 101 |
| 5 minutes | 199 | 203 | 183 | 198 | 251 | 130 |
| 1 hour | 218 | 210 | 223 | 218 | 295 | 132 |
| 24 hours | 238 | 261 | 313 | 279 | 329 | 169 |
| 24 hours @ | 51 | 124 | 110 | 85 | 156 | 81 |
| 90% Relative | | | | | | |
| humidity | | | | | | |
| 1 hour | | | | | | |
| Bench life | | | | | | |
| 30 seconds | 149 | 178 | 112 | 138 | 148 | 102 |
| 24 hours | 250 | 290 | 229 | 254 | 301 | 178 |
| 3 hours | | | | | | |
| bench life | | | | | | |
| 30 seconds | 121 | 133 | 100 | 120 | 143 | 73 |
| 24 hours | 193 | 220 | 185 | 188 | 259 | 127 |

The above data demonstrate poor tensile strength after 24 hours in high humidity conditions in Example A, where both the alkyl silicate and the bipodal aminosilane are absent, and Example F, which contains a well-known silane coupling agent instead of the alkyl silicate and/or the bipodal aminosilane.

Between Examples A and B, it is seen that addition of TEOS by itself as the alkyl silicate Part II additive increases tensile strength across the board under different bench life conditions.

Examples C and D, when compared to each other and to the baseline Example A, show that the bipodal aminosilane, when present without the alkyl silicate, increases the tensile strength over situations where it is absent, although the value may be diminishing, as the 2% addition (Example D) provided better results than the 4% addition.

When adding a comparison of Example E to either Example A or B, it is seen that the presence of both alkyl silicate and bipodal aminosilane provides a better product than with a Part III additive containing only alkyl silicate. It is noted that the ratio of alkyl silicate to the bipodal aminosilane has not been optimized in the experimental data provided, nor has the amount of the Part III additive present, relative to the binder weight.

The above cases demonstrate the use of the inventive concept with a cold box method.

Experiments were also conducted to demonstrate the concept with a “no bake” method, using the applicant company's commercially available PEP SET technology, which represents liquid amine-cured polyurethane chemistry. In the following examples, four different PEP SET systems were tested. In each example, a base case was established without any Part III additive. Then, an experiment was conducted using a Part III additive that is mixture of 3 parts by weight TEOS per 1 part by weight of DYNASYLAN 1124 being added. This is the same additive used in Example E above. The Part III additive in these examples is being used at 4% by weight based on the binder, which is identical to that in Example E.

In the first of these experiments, the Part I and Part II components were PEP SET X 11000 and PEP SET X II 2000, respectively, present in the amounts of 0.550 and 0.450 g/100 g of sand. Also present was PEP SET CATALYST 3501, in the amount of 0.033 g/100 g of sand. The sand used was WEDRON 410. This is a commercially-available and useful system. This baseline experiment produced a molding compound that had a work time of 2.75 minutes and a strip time of 3.25 minutes. As is well-known, “work time” can loosely be understood as an expression of the time that elapses between mixing the binder components with the sand until the foundry shape being formed reaches a hardness that effectively precludes further working in the pattern. More technically, “work time” is the time elapsed for the foundry shape formed to reach a level of 60 on the Green Hardness “B” scale, using a gauge sold by Harry W. Dietert Co, of Detroit, Mich. Details of the test are found many places, including in commonly-owned U.S. Pat. No. 6,602,931. “Strip time” loosely defines the elapsed time from mixing the binder components with the sand until the formed foundry shape is able to be removed from the pattern. In the technical sense used here, the “strip time” is the time needed for the foundry shape formed to attain a level of 90 on the same Green Hardness “B” scale. The difference between strip time and work time is, therefore, an amount of dead time during which the mold being formed cannot be worked upon, but cannot yet be removed from the pattern.

In this experiment, the tensile strength of the formed shapes was 194 psi at one hour and 256 psi at 24 hours. The 24-hour tensile strength in a 90% relative humidity environment was 62 psi.

When the Part III component was introduced and the experiment repeated using the PEP SET X I 1000/PEP SET X II 2000/PEP SET CATALYST 3501 system, there was very little change in the work time or strip time, as the work time remained at 2.75 minutes and the strip time increased to 3.50 minutes. However, the 1-hour tensile strength increased to 212 psi (from 194) and the 24-hour tensile strength increased from 256 to 306 psi. Most notably, the 24-hour tensile strength in the 90% relative humidity environment jumped to 327 psi from 62 psi.

In the second experiment using a “no-bake” formulation, the Part I component was changed to PEP SET 1010 HR, which contains HF, as disclosed in U.S. Pat. No. 6,017,978. The Part II component was unchanged from first experiment (PEP SET XII 2000). The respective amounts were unchanged (at 0.550 and 0.450 g/100 g of sand). The catalyst was changed from PEP SET CATALYST 3501 to PEP SET CATALYST 308, but the amount remained constant at 0.033 g/100 g of sand. As before, the sand used was WEDRON 410. This second commercially-available and useful system established a baseline molding compound with a work time of 3.25 minutes and a strip time of 3.50 minutes, using the Dietert gauge. In this experiment, the tensile strength of the formed shapes was 211 psi at one hour and 378 psi at 24 hours. The 24-hour tensile strength in a 90% relative humidity environment was 256 psi.

When the Part III component was introduced and the experiment repeated using the PEP SET 1010 HR/PEP SET X II 2000/PEP SET CATALYST 308 system, there was very little change in the work time or strip time, as the work time remained at 3.25 minutes and the strip time increased from to 3.50 minutes to 4.00 minutes. However, the 1-hour tensile strength increased to 237 psi (from 211) and the 24-hour tensile strength increased from 378 to 394 psi. As in the first experiment, the most notable effect was an increase of the 24-hour tensile strength in the 90% relative humidity environment, from 256 to 324 psi.

In the third of four PEP SET experiments demonstrating the utility of the three-part binder system, the first part was PEP SET 5140 and the second part was PEP SET 5230, both commercially-available from ASK Chemicals. The catalyst was PEP SET 5325, applied at 3% based the weight of the PEP SET CATALYST 5140. With no third part additive, the work time was 9 minutes and the strip time was 11 minutes. Tensile strengths at 1 hr. and 24 hrs. were 128 and 217 psi, respectively, but the 24 hr. tensile strength at 90% relative humidity dropped to an unacceptable 37 psi. When this test was repeated with the third part being the mixture of 3 parts by weight TEOS per 1 part by weight of DYNASYLAN 1124, added at 4% by weight of the binder, the work time and strip time declined to 3.25 and 4 minutes, respectively, but the 1 hr. tensile strength increased to 177 psi, the 24 hr. tensile strength increased to 252 psi and, most impressively, the 24-hour tensile strength in 90% relative humidity not only did not decline, but in fact increased to 264 psi.

In the fourth PEP SET experiment, the first part was PEP SET 8000 PLUS and the second part was PEP SET 8200, both commercially-available from ASK Chemicals. The catalyst was PEP SET CATALYST 8305, applied at 4% based the weight of the PEP SET 8000 PLUS. PEP SET 8000 PLUS is described in U.S. Pat. No. 6,632,856. With no third part additive, the work time was 5.25 minutes and the strip time was 8 minutes. Tensile strengths at 1 hr. and 24 hrs. were 138 and 184 psi, respectively, but the 24 hr. tensile strength at 90% relative humidity dropped to an unacceptable 32 psi. When this test was repeated with the third part being the mixture of 3 parts by weight TEOS per 1 part by weight of DYNASYLAN 1124, added at 4% by weight of the binder, the work time and strip time each increased, to 7.75 and 11.5 minutes, respectively. The 1 hr. and 24 hr. tensile strengths were effectively unchanged, at 135 and 186 psi, respectively. However, the 24 hr. tensile strength in 90% relative humidity was 98 psi. While this is a decrease from the 1 hr. tensile strength, it is significantly higher than the 32 psi that resulted in the absence of the third part additive.

It is believed to be clearly seen from the “no-bake” examples that the use of the Part III additive, especially a Part III additive that includes both an alkyl silicate and a bipodal aminosilane, increases the ability of a formed foundry shape to maintain tensile strength over at least a 24-hour period in a high humidity condition. The improved ability to maintain tensile strength is achieved with essentially no effect on work time or strip time. As noted above, the ratio of alkyl silicate to bipodal aminosilane is not optimized.

The success encountered above led to further experimentation with other curing systems. A proprietary binder that is commercially available from ASK Chemicals is the ISOSET binder, which has been described in U.S. Pat. No. 4,526,219 to Dunnavant. The ISOSET binder system is an epoxy and acrylate hybrid binder chemistry, cured by sulfur dioxide. In that patent, a cold-box process for making foundry shapes is disclosed. Certain ethylenically unsaturated materials are cured by a free radical mechanism in the presence of a free radical initiator and vaporous sulfur dioxide. As with the other systems disclosed here, the binder is packaged in two parts. The Part I and Part II of the binder are mixed with a foundry aggregate, typically sand, to form a foundry mix. The total amount of binder used to form the foundry mix is typically from about 0.5 to 2 weight percent based on sand. The foundry mix is blown or compacted into a pattern where it is gassed with sulfur dioxide to produce a cured core or mold. Foundry mixes made with these binders have extended benchlife and foundry shapes made with the binder have excellent physical properties.

In the ISOSET binder system, the most commonly used multifunctional acrylate is trimethylolpropane triacrylate (“TMPTA”). The hydroperoxide most commonly used is cumene hydroperoxide. In the ISOSET experiment using a Part III additive in a cold box binder application, there were three tests conducted. In the first, a baseline was established by using no Part III additive. In the second test, a 4% by weight based on binder amount of DYNASYLAN 1124 was used as the Part III additive. In the third test, the Part III additive was a mixture of 3 parts by weight TEOS per 1 part by weight of DYNASYLAN 1124, the additive being applied at a 4% weight amount based on the binder.

In the ISOSET test, a Wexford lake sand was used as the foundry aggregate, with the binder present at 1.5% by weight based on the sand. The Part I was ISOSET I 4304 and the Part II was ISOSET II 4305NS, the Parts being present in a 55/45 ratio. The samples were gassed with a 35% sulfur dioxide blend in nitrogen.

Transverse strengths were measured instead of tensile strengths. With no Part III additive, a zero hours bench life foundry mix had a strength of 32 psi at 30 seconds, which increased to 53 psi at 5 minutes. The transverse strength remained essentially constant at 54 psi at 1 hour and declined to 40 psi at 24 hours. However, under 90% relative humidity, the 24-hour transverse strength was only 25 psi.

Using the 4% by weight DYNASYLAN 1124 Part III additive, the second test was conducted. Under the same conditions, the 30 second transverse strength was slightly better at 38 psi and was also slightly better at 59 psi after 5 minutes. However, at 1 hour, the presence of the DYNASYLAN 1124 additive increased the strength to 71 psi and this increase over the baseline was seen again at 24 hours, with a 63 psi strength. Under 90% relative humidity, the DYNASYLAN 1124 Part III additive had a decline to 45 psi after 24 hours, but this was still higher than the baseline strength of 40 psi observed in dry conditions.

In the third experiment, the mixture of TEAS and DYNASYLAN 1124 was similar at 30 seconds to the baseline system (29 psi compared to 32 psi). At 5 minutes, it was also similar (59 psi compared to 53 psi). However, at 1 hour and at 24 hours, the strengths of 64 and 59 psi exceeded the baseline strengths of 54 and 40. In fact, it is notable that this third system lost much less of its strength between 1 and 24 hours than the other systems. As with the DYNASYLAN 1124 Part III additive, the 24-hour strength under 90% relative humidity was much better than in the baseline, at 39 psi.

This ISOSET experiment shows that a Part III combination of alkyl silicate and bipedal aminosilane increased the strength of a formed foundry shape after 24 hours in 90% relative humidity, when compared to a baseline case without the Part III additive.

A yet further set of experiments was conducted to test another binder system used conventionally in the cold box process. In this case, the system was an ISOMAX system, commercially available from ASK Chemicals. The ISOMAX system is based on amine-curable acrylate epoxy isocyanate chemistry, as described in U.S. Pat. Nos. 5,880,175, 6,037,389 and 6,429,236. Part I of the system tested was ISOMAX 161 and Part II was ISOMAX 271. In the ISOMAX system, Part I typically contains a phenolic resin, epoxy, cumene hydroperoxide, solvents and additives. The Part II component typically contains MDI, acrylates and bench life extenders. Triethylamine is used as a catalyst.

Two baseline experiments were conducted, in which no Part III additive was present. In the first baseline case, a zero-hour bench life run was made. In the second baseline case, the foundry mix had a three-hour bench life. After 30 seconds for the first baseline, the tensile strength was 119 psi. This increased to 146 psi at 5 minutes and to 153 psi at one hour. Under dry conditions, the tensile strength was at 154 psi after 24 hours. However, under 90% relative humidity, the tensile strength dropped to 57 psi. The three-hour bench life baseline experiment had a 100 psi tensile strength at 30 seconds and this only increased to 111 psi after 24 hours.

The remainder of the ISOMAX experiment was conducted, using the same Part III additives used previously.

Using the 4% by weight DYNASYLAN 1124 Part III additive, the ISOMAX experiment was repeated. Under the same conditions, the 30 second strength was better at 152 psi and was also better at 201 psi after 5 minutes. The tensile strength continued to increase, measuring 234 psi at 1 hour and 261 psi at 24 hours, under dry conditions. Under 90% relative humidity, the DYNASYLAN 1124 Part III additive declined to 193 psi after 24 hours, but this was still better than the best baseline strength of 154 psi, and that was observed in dry conditions, not under high humidity. In a similar manner, the three-hour bench life test showed 132 psi after 30 seconds and 216 psi after 24 hours under dry conditions.

When the experiment was repeated using a Part III additive that was 4% by weight (based on binder) of 3 parts TEOS and 1 part DYNASYLAN 1124, the results were better than the baseline, but not as good as when only DYNASYLAN 1124 was used. In the zero bench life test, the tensile strength was 141 psi at 30 seconds and increased to 190 psi at 54 minutes. 212 psi at one hour and 221 psi at 24 hours under dry conditions. Exposure to 90% relative humidity for 24 hours resulted in a tensile strength of 178 psi. This was not better than the 4% DYNASYLAN 1124 system (at 193), but was better than any of the tensile strengths, regardless of time, in the baseline experiments. The three-hour bench life experiment using this Part III additive provided a result of 125 psi after 30 seconds and 200 psi after 24 hours, both in dry conditions. This result is intermediate to the baseline tests and the tests using 4% DYNASYLAN 1124.

A final set of experiments was conducted to demonstrate the inventive concept using a CHEM REZ “no-bake” binder system, which represents acid cured furfuryl alcohol-based resin chemistry. In this case, a Wedron 410 sand was used as the foundry aggregate, with the binder present at 1.0% by weight based on the sand. The specific binder was CHEM REZ FURY 484 and the catalyst was CHEM REZ C2009, applied at 40% based on the binder. A base line test (with no additive) provided a work time of 4 minutes and a strip time of 7.75 minutes. Tensile strength was 102 psi at 1 hour and increased to 211 psi at 24 hours, with a tensile strength of 115 psi at 24 hours at 90% relative humidity.

When the experiment was repeated with the same binder system but with 4% TEOS/DYNASYLAN 1124 system (75/25 blend), work time increased to 5 minutes and strip time increased to 9 minutes. The tensile strength at 1 hour was 92 psi and, after 24 hours, the tensile strength was 195, both of which were acceptably lower than in the base line experiment. However, the tensile strength after 24 hours at 90% relative humidity actually was higher than the base line, at 147 psi.

The data presented above show the clear advantage of the Part III additive when used in conjunction with a binder provided by combining Parts I and II as described above. While the data exhibit the results obtained from mixing the Part III additive to the Parts I and II at the time of combining Parts I and II, the invention would not appear to be limited to this. It is believed to be within the scope of the invention to apply the Part III additive to the sand before the combined Parts I and II are added to the sand for mixing in the conventional manner. It is also believed to be within the scope of the invention to add the Part III additive after Parts I and II are combined and mixed with the sand, even after the foundry mix formed thereby has been formed into a molding shape. The addition of the Part III additive in this situation could be achieved by adding it with the gaseous curing amine or by spraying it onto the surfaces of the molding shape, especially the surfaces that will be in contact with the molten metal.

What is claimed is:

1. A binder system for a molding material mixture, comprising:
(A) a first organic binder component;
(B) a second organic binder component, complementary to the first organic binder component; and
(C) an alkyl silicate component;
wherein (A), (B) and (C) are provided as a three component system in separate containers for combination at the time of use.

2. The binder system of claim 1, wherein:
(A) is a polyol component, comprising a phenolic base resin with at least 2 hydroxy groups per molecule, the polyol component being devoid of polyisocyanates; and
(B) is a polyisocyanate component, comprising a polyisocyanate compound with at least 2 isocyanate groups per molecule, the isocyanate component being devoid of polyols;
such that (A) and (B) comprise a phenolic urethane chemistry, which, when combined and cured with an amine catalyst results in a phenolic urethane polymer.

3. The binder system of claim 2, wherein the alkyl silicate component comprises tetraethyl orthosilicate (TEOS).

4. The binder system of claim 2, wherein the alkyl silicate comprises an oligomer of an alkyl silicate.

5. The binder system of claim 1, wherein (C) her comprises a bipodal aminosilane.

6. The binder system of claim 5, wherein the bipodal aminosilane is bis(trimethoxysilylpropyl)amine.

7. The binder system of claim 1, wherein (A) further comprises hydrofluoric acid.

8. The binder system of claim 3, wherein both (A) and (B) further comprise hydrofluoric acid.

9. The binder system of claim 5, wherein (C) is a 75% by weight TEOS, 25% by weight bipodal aminosilane mixture.

10. The binder system of claim 9, wherein (C) is present at 4% of the weight of the binder.

11. A molding material mixture, comprising:
a refractory mold base material; and
a binder system according to claim 1.

12. The binder system of claim 1, wherein the alkyl silicate component comprises tetraethyl orthosilicate (TEOS).

13. The binder system of claim 1, wherein the alkyl silicate comprises an oligomer of an alkyl silicate

14. The binder system of claim 4, wherein both (A) and (B) further comprise hydrofluoric acid.

15. A binder system for a molding material mixture, comprising:
(A) a first binder component that is a polyol, comprising a phenolic base resin with at least 2 hydroxy groups per molecule, the first binder component being devoid of polyisocyanates;
(B) a second binder component that is a polyisocyanate, comprising a polyisocyanate compound with at least 2 isocyanate groups per molecule that is complementary to the first binder component such that (A) and (B) comprise a phenolic urethane chemistry, which, when combined and cured with an amine catalyst results in a phenolic urethane polymer, the second binder component being devoid of polyols; and
(C) an alkyl silicate component comprising tetraethyl orthosilicate (TEOS) or an oligomer of an alkyl silicate, as well as a bipodal aminosilane;
wherein (A), (B) and (C) are provided as a three component system in separate containers, and at least component (A) also comprises hydrofluoric acid.
